(19) United States
(12) Patent Application Publication
(10) Pub. No.: US 2025/0201870 A1
(43) Pub. Date: Jun. 19, 2025

(54) METHOD AND APPARATUS FOR MANUFACTURING A MEMBRANE-ELECTRODE ASSEMBLY

(71) Applicant: MB Automation GmbH & Co. KG, Roding (DE)

(72) Inventor: Sven Hochmann, Dresden (DE)

(21) Appl. No.: 18/843,460

(22) PCT Filed: Mar. 10, 2023
(86) PCT No.: PCT/EP2023/056099

§ 371 Date: Sep. 3, 2024

(30) Foreign Application Priority Data
Mar. 11, 2022 (DE) 102022105785.2

(51) Int. Cl. H01M 8/0273; H01M 4/88; H01M 8/1004

(52) U.S. Cl. CPC H01M 8/0273; H01M 4/881; H01M 8/1004

(57) ABSTRACT

An apparatus for manufacturing a membrane electrode arrangement comprises at least one first transport apparatus, which is set up to convey at least one first carrier frame at a first conveying speed, and a first arranging apparatus in the form of a vacuum drum, which is set up to arrange at least one membrane on the at least one first carrier frame while the latter is being conveyed by the first transport apparatus. Furthermore, the apparatus for manufacturing a membrane-electrode arrangement comprises a second arranging apparatus in the form of a vacuum drum, which is set up to arrange at least one second carrier frame on the membrane while the latter is conveyed together with the first carrier frame by the first transport apparatus.

### CROSS-REFERENCE TO RELATED APPLICATIONS

This application is a National Stage application of International Application No. PCT/EP2023/056099 filed Mar. 10, 2023, which claims priority to German Patent Application Serial No. DE 102022105785.2 filed Mar. 11, 2022.

### BACKGROUND

### Field

A method and an apparatus for manufacturing a membrane electrode arrangement, for example a membrane electrode arrangement for a fuel cell, are described here. Details thereof are defined in the claims, however, the description also contains relevant information on the structure and mode of operation as well as on variants.

### Discussion of the Related Art

A known method for manufacturing a membrane electrode assembly for a fuel cell is the so-called pick-and-place method. Here, handling machines, robots or grippers set up on rails are used, which can perform movements in different spatial directions in order to place the different components of the respective membrane electrode arrangement with the required accuracy. Such a pick-and-place process for manufacturing membrane electrode assemblies and fuel cells in large-scale manufacturing is challenging in terms of material costs and also due to the handling of the delicate and sensitive components required.

It is also known to provide a support for a membrane and/or an electrode as part of a continuous web of material. Alternatively, a membrane and/or an electrode can also be provided as a web of material. In this case, the material web can pass through a plurality of processing stations, whereby at least a second component of the membrane/electrode arrangement is connected to the material web. DE 10 2015 010 440 A1, for example, discloses such a process.

Document DE 10 2015 214 361 A1 also discloses a method in which components of a membrane electrode assembly can be provided as continuous material webs. The components of the membrane electrode assembly pass through several manufacturing stations during the manufacturing of the membrane electrode assembly and are exchanged between different transport apparatuses.

Further membrane electrode arrangements and associated manufacturing processes are known from the documents DE 10 2010 049 548 A1, DE 10 2010 054 199 A1 and DE 10 2011 105 180 A1.

If a membrane electrode arrangement is to be produced for a fuel cell, which is to have at least two carriers provided with recesses and a membrane set up between the carriers, it is necessary to arrange the carriers with the recesses precisely on top of each other. If the carriers are provided and conveyed as a continuous material web, there is the problem that the membrane to be set up between the carriers at least partially covers the recesses in the respective carriers. This makes it difficult to arrange the carriers precisely on top of each other, as the carriers provided as a web of material and connected to each other do not have any cut edges in the conveyor direction that could serve as references for positioning the carriers. At the same time, even a small amount of slippage when conveying the n carriers to be set up on top of each other can lead to a positioning error of the carriers provided as web material increasing steadily over the course of a manufacturing process, so that any specified manufacturing tolerance for the membrane electrode arrangement is violated at some point during a manufacturing process.

There is therefore a need for an improved manufacturing process and an improved manufacturing apparatus for manufacturing a membrane electrode arrangement, which in particular improves the precision of the superimposition of two carrier frames, each provided as a quasi-infinite web material.

### SUMMARY

An apparatus for manufacturing a membrane electrode assembly, MEA, comprises a first transport apparatus which is set up to convey at least one first carrier frame at a first conveying speed. A first arranging apparatus, for example in the form of a vacuum drum, is set up to arrange at least one membrane on the at least one carrier frame while it is being conveyed by the first transport apparatus. A second arranging apparatus, for example in the form of a vacuum drum, is set up to arrange at least one second carrier frame on the membrane while it is conveyed together with the first carrier frame by the first transport apparatus.

In a variant, the carrier frames, in particular the first carrier frame and/or the second carrier frame, are each provided as quasi-infinite and/or continuous web material, for example from a carrier web roll. In the case of a quasi-infinite and/or continuous web material, several carrier frames, in particular of the same type, are connected to each other and/or not (yet) separated from each other. In other words, carrier frames provided as web material form a one-piece sequence of several carrier frames, which can be separated or separated from each other at a later time, for example with a cutting apparatus. In a variant, the carrier frames, in particular the first and/or the second carrier frame, are each provided with or without recesses, in particular with a first recess or without a first recess.

In a variant, the carrier frames, in particular the first carrier frame and/or the second carrier frame, can be provided as a continuous web material together with a carrier layer, for example one that is permeable to gas or air, for example by the carrier web roller. In particular, the carrier frames can be set up and/or fixed to/on the carrier layer with an adhesive application that can be activated/released by heat and/or with an adhesive application that can liquefy depending on the temperature. In particular, the adhesive application can be a full-surface adhesive application. Tension forces occurring during conveying and/or tension forces caused by conveying can be absorbed or compensated for by the carrier layer. In this way, no or hardly any (tensile or clamping-) forces act on the carrier frames themselves during conveying, in particular no or hardly any (tensile or clamping) forces in the conveying direction of the carrier frames and the carrier layer. Damage to the carrier frames can thus be counteracted.

In a variant, the cutting apparatus comprises in particular a cutting cylinder. A cutting cylinder is in particular a cutting roller or other rotating cutting apparatus that is suitable for cutting or separating an MEA component provided as continuous web material, for example the carrier frames provided as web material, into several MEA component sections, in particular into several individual or separate carrier frames. However, in other variants, other separating or cutting apparatuses can also be used for cutting or separating an MEA component provided as continuous web material into several MEA component sections, expressly including those that do not have rotating (cutting) elements.

In a variant, the cutting apparatus can be set up to cut or sever an MEA component provided as continuous web material, for example the carrier frames provided as web material, into a plurality of MEA component sections, in particular into a plurality of individual or separate carrier frames, while the first MEA component is set up on a carrier layer.

One advantage of using vacuum drums is that they can convey the membranes provided as web material and the carrier frames provided as web material without slippage, which improves the precision of the arrangement of the membrane and the carrier frames. Optionally, one or more vacuum drums, for example the second arranging apparatus, can also be set up to convey the at least one first carrier frame and/or the at least one second carrier frame, in particular without slippage, while this/these is/are set up on a carrier layer.

A vacuum drum is a conveyor drum or a conveyor cylinder that is suitable for conveying a web of material, for example carrier frames provided as quasi-infinite web material for a membrane electrode arrangement and/or a membrane or membrane sections for a membrane electrode arrangement and/or other components for a membrane electrode arrangement or one or more individual MEA components from sections, in particular without slippage. The vacuum drum is set up to fix the material web or the material web sections to a drum or cylinder shell surface by means of a negative pressure. The negative pressure can, for example, act on the MEA component and/or the MEA components sections by means of openings in the drum or cylinder shell surface or by means of a cylinder shell surface that is at least partially porous over its entire surface and fix them to the drum or cylinder shell surface. A vacuum drum is also called a negative pressure drum.

The openings in the drum or cylinder shell surface and/or the vacuum acting through these openings can be selectively activated or deactivated by a control system and/or controlled or regulated depending on a rotation of the vacuum drum and/or depending on predetermined time intervals.

Optionally, the release of the MEA component and/or the MEA component sections can comprise the cancellation of the negative pressure and/or a brief reversal from negative pressure to positive pressure. In other words, by cancelling or controlled compensation of a negative pressure acting on the MEA component and/or the MEA component sections, a fixation of the MEA component and/or the MEA component section on the drum or cylinder shell surface of the vacuum drum can be cancelled. Furthermore, the vacuum drum can be set up and designed to press or roll an MEA component and/or an MEA component section against another MEA component, for example on a carrier web, during arrangement on this other MEA component.

Further, the apparatus for manufacturing a membrane electrode assembly may comprise one or more adhesive application apparatuses, for example one or more adhesive material application apparatuses in the form of a rotary screen printer adapted to print an adhesive onto one of the MEA components. For example, the apparatus for manufacturing a membrane electrode arrangement can have an adhesive application before rich apparatus that is set up to apply an adhesive coating to the at least one first carrier frame. Alternatively, or additionally, the apparatus for manufacturing a membrane electrode arrangement can also have an adhesive application apparatus which is set up to apply an adhesive to the at least one second support frame and/or to the membrane. The adhesive application, which is applied to the first and/or second support frame and/or to the membrane, can be here, for example, a full-surface adhesive application or an adhesive application in the form of an adhesive frame. In particular, the adhesive frame can completely form or reshape at least a first formation in the first carrier frame or in the second carrier frame.

The arrangement of the membrane and/or of the at least one second support frame on the at least one first support frame can comprise a materially bonding thermal joining process, in particular a lamination process. Alternatively, the arrangement of the membrane and/or of the at least one second support frame on the at least one first support frame can comprise a cold lamination process, which fixes the second MEA component or the MEA component section on the first MEA component.

Optionally, a separate lamination apparatus and/or a separate heating apparatus and/or a separate curing apparatus can be provided for this purpose. A pressing apparatus, in particular a separate pressing apparatus, which is designed and set up to press the MEA components, for example the first and/or the second carrier frame and/or the membrane, and/or MEA component sections against each other, may also be provided. Alternatively, or additionally, the membrane and the at least one second support frame can also be pressed or rolled onto the first support frame with/through the vacuum drums of the respective arranging apparatuses.

The first and/or the second arranging apparatus can be set up to continuously convey the membrane and/or the at least one second support frame. Furthermore, the first and/or the second arranging apparatus can, alternatively or additionally, be set up to convey the membrane and/or the second support frame at least partially or in sections along a circular path or along a circular path section. The circular path and/or the circular path section can, for example, be essentially defined or predetermined by a lateral surface of the vacuum drum of the respective arranging apparatus. The vacuum drums of the first and/or the second arranging apparatus can be set up to be rotated or turned about a first axis of rotation so that an MEA component, for example a membrane or a carrier frame, fixed on the lateral surface of the respective vacuum drum by means of a vacuum, is moved along a circular path or a circular path section.

The second arranging apparatus can in particular be a heatable or warmable vacuum drum, which is set up to liquefy and/or dissolve by the influence of heat a full-surface and/or temperature-dependent liquefiable/dissolvable adhesive application, with which the at least one second carrier frame is set up/fixed on a, in particular second, carrier layer, so that the second carrier frame can be detached and/or released from the carrier layer and/or from the second arranging apparatus.

The first arranging apparatus can be designed to interact with a cutting apparatus which is set up to cut or separate a membrane prepared as a continuous web material into a plurality of MEA component sections, namely a plurality of membrane sections, while the membrane is conveyed or moved by the first arranging apparatus.

The cutting apparatus for the membrane can in particular comprise a cutting cylinder. In particular, a cutting cylinder can be a cutting roller or other rotating cutting apparatus that is suitable for cutting or separating an MEA component provided as continuous web material, for example the membrane provided as web material, into a plurality of MEA component sections, for example into a plurality of isolated or separated membrane sections. However, in other variants, other separating or cutting apparatuses can also be used for cutting or separating an MEA component provided as continuous web material into several MEA component sections, expressly including those that do not have any rotating (cutting) elements.

Furthermore, the vacuum drum of the first arranging apparatus can have a rubber or plastic coating on its casing surface or jacket surface and/or be at least partially made of a rubber or plastic material. One advantage of the rubber or plastic coating is that the blades of the cutting cylinder and/or an, in particular first, rotary punching press can be protected from damage due to direct contact with the jacket surface or jacket surface of the vacuum drum of the first arranging apparatus. The first arranging apparatus can thus also be protected from damage by the cutting cylinder and/or a rotary punch. In a variant, the rubber or plastic coating can be limited to a part of the jacket surface or the jacket surface which comes into contact with blades of the cutting cylinder and/or a rotary punch.

Alternatively, the vacuum drum of the first arranging apparatus can have an adhesion reducing coating, in particular a PTFE (Teflon®) coating. One advantage of this is that the second membrane can be pressed or rolled onto the at least one first carrier frame with/through the vacuum drum of the first arranging apparatus with the adhesion-reducing coating. Due to the adhesion-reducing coating, the membrane or the membrane sections can be detached from the vacuum drum particularly well and incorrect positioning of the membrane or membrane sections due to adhesion or irregular detaching the membrane or the membrane sections from the vacuum drum of the first arranging apparatus can be avoided. As a result, both manufacturing precision and manufacturing speed can be improved.

In a variant, the vacuum drum of the first arranging apparatus has both a rubber or plastic coating and an adhesion-reducing coating on its jacket surface or jacket surface. The different coatings can be set up on different sections or partial surfaces of the shell surface or jacket surface.

The first transport apparatus can, for example, be a first vacuum conveyor belt, in particular a circulating one. Furthermore, the first transport apparatus can be set up to convey the at least one first carrier frame continuously or cyclically at the first conveyor speed. The first transport apparatus can also be set up to convey the at least one first carrier frame in the form of a web material or in the form of several MEA component sections of the first MEA component and/or to fix/hold it in place during conveying by means of a vacuum. The first transport apparatus can convey the at least one first carrier frame without tension, in particular. Tension-free means that no (tensile) force is exerted on the web material in the conveying direction during the conveying of a web material. In other words, tension-free means that the carrier frames provided as web material have no or hardly any material tension caused by the conveying in a direction parallel to the conveying direction.

In a variant, the first transport apparatus can be set up to convey the at least one first carrier frame in the form of a web material or in the form of several MEA component sections of the first MEA component while this/these is/are set up on a carrier layer.

Optionally, the first vacuum conveyor belt can be set up to convey the at least one first carrier frame together with a first MEA component, wherein the at least first carrier frame is set up on the first MEA component.

One advantage here is that the first support frame can already be set up on a first MEA component and/or on sections of the first MEA component, for example on a gas diffusion layer, GDL. This can further facilitate and accelerate the manufacturing of a membrane electrode arrangement with two support frames.

Furthermore, the apparatus for manufacturing a membrane electrode arrangement can have a third arranging apparatus, in particular a third arranging apparatus in the form of a vacuum drum, which is set up to arrange the at least one first carrier frame on the MEA component conveyed by the first vacuum conveyor belt, so that the first vacuum conveyor belt can convey the at least one first carrier frame together with a first MEA component.

One advantage here is that the first carrier frame can be set up on a first MEA component provided as a quasi-infinite web material, for example on a GDL, and/or on separated sections of the first MEA component, so that the further manufacturing of the membrane electrode arrangement with two carrier frames can already be continued with a one carrier frame set up on a first MEA component or sections of a first MEA component.

In a further variant, the first transport apparatus itself can be designed as a vacuum drum. In this case, the first transport apparatus can also be set up to convey the first carrier frame continuously at a first conveying speed. Furthermore, the first transport apparatus can also be set up in this case to convey the at least one first carrier frame while it is set up on a carrier layer.

One advantage here is that a vacuum drum can convey the first carrier frame(s) provided as continuous web material with even greater precision than a vacuum transfer belt. Furthermore, if the first carrier frame itself is conveyed by a vacuum drum, no or only reduced material tension or material elongation occurs within the membrane and/or the second carrier frame when the membrane and/or the second carrier frame are set up on the first carrier frame, since these do not have to be rolled from a curved lateral surface of a vacuum drum onto a flat conveyor belt, but are instead transferred from one curved surface to another curved surface. In addition, the use of a vacuum drum as the first transport apparatus allows a particularly compact design of the apparatus for manufacturing a membrane electrode arrangement as well as simpler adjustment stim of the conveying speeds of the individual MEA components.

The apparatus for manufacturing a membrane-electrode arrangement can further comprise a fourth arranging apparatus, in particular a fourth arranging apparatus in the form of a vacuum drum or in the form of a pressure roller without vacuum or negative pressure function, which is set up to arrange the at least one first support frame together with the membrane and together with the at least one second support frame on a first MEA component.

The third and fourth arranging apparatuses can each be implemented independently of one another. In particular, an apparatus for manufacturing a membrane electrode arrangement can have a fourth arranging apparatus without the apparatus having a third arranging apparatus. In another variant, the apparatus for manufacturing a membrane electrode arrangement can have a third arranging apparatus without the apparatus having a fourth arranging apparatus.

Furthermore, the apparatus for manufacturing a membrane electrode arrangement can optionally have a fifth arranging apparatus, in particular a fifth arranging apparatus in the form of a vacuum drum, which is set up to arrange a second MEA component, in particular a GDL, on a surface of the arrangement comprising the first MEA component, the at least one first support frame, the membrane and the at least one second support frame facing away from the first MEA component.

One advantage here is that a membrane-electrode arrangement with two carrier frames, a membrane and two GDLs can be achieved by continuously conveying carrier frames provided as web material.

The first and/or second carrier frames provided as web material can be separated or singled from one another, for example with a cutting apparatus, in particular by a cutting apparatus with a cutting cylinder. The first and second carrier frames provided as web material can be separated or singled from one another after they have been set up against one another and/or against/on the membrane or the membrane sections so that several MEA component sections are produced, each of which has at least one first carrier frame and at least one second carrier frame and at least one membrane section set up between the carrier frames. In particular, after the arranging the second MEA component(s), the first and second carrier frames can be fed by the fifth arranging apparatus to a cutting apparatus which separates or separates the first and second carrier frames provided as web material, so that a plurality of membrane electrode arrangements are produced, each having at least one first carrier frame and at least one second carrier frame.

The first MEA component can comprise a gas diffusion layer, GDL, in particular an anode or a cathode in the form of a GDL. The second MEA component can comprise a gas diffusion layer, GDL, in particular an anode or a cathode in the form of a GDL. In particular, the membrane can be a catalyst-coated membrane, CCM. The first and/or the second MEA component and/or the membrane can each be provided as roll material or as web material from a roll of material.

In a variant, the apparatus for manufacturing a membrane electrode arrangement can have a first and/or a second punching apparatus, in particular a first and/or a second rotary punching apparatus. The first punching apparatus can be set up to make one or more recesses, in particular a first recess, in the at least one first carrier frame, for example while the latter is being conveyed by a vacuum drum or by the first transport apparatus. The second punching apparatus can be set up to make one or more recesses, in particular a first recess, in the at least one second carrier frame, in particular while the latter is being conveyed or moved by the second arranging apparatus.

Optionally, the cutting apparatus and/or the first and/or second punching apparatus can be designed as a vacuum drum or have apparatus elements designed as a vacuum drum. One advantage here is that MEA component sections punched out of the carrier frames and/or excess MEA component sections can be fixed by the vacuum drum of the cutting apparatus and/or the first or second rotary punching apparatus and/or can be detached and/or transported away from the vacuum drum of the first arranging apparatus.

In one embodiment, the apparatus for manufacturing membrane-electrode arrangements can have a further punching apparatus, in particular a rotary punching apparatus, which is designed and set up to introduce further recesses, in particular in the conveying direction before and after a respective recess, into the first carrier frame and/or into the second carrier frame, while these are conveyed together with a membrane set up between them by the first transport apparatus and/or by a vacuum drum. The further recesses can completely penetrate both the first carrier frame and the second carrier frame, whereby the membrane can in each case cover or close the first recess in the carrier frame, but does not cover or close and/or tangent the respective further recesses.

In a variant, the apparatus for manufacturing membrane electrode arrangements can have a first carrier layer receiving apparatus, in particular in the form of a carrier layer roller, which is set up to receive a carrier layer after at least a part of the at least one first carrier frame has been detached from it. Furthermore, the apparatus can have a second carrier layer receiving apparatus, in particular in the form of a carrier layer roller, which is set up to receive a carrier layer after at least a part of the at least one second carrier frame has been detached from it.

In one embodiment, the apparatus for manufacturing a membrane electrode arrangement can also have a second transport apparatus, which can in particular be a vacuum conveyor belt. The second transport apparatus can be set up and designed to convey the first MEA component at a second conveying speed. Furthermore, the second transport apparatus can be set up and designed to convey the first MEA component continuously or cyclically at the second conveying speed. Furthermore, the second transport apparatus can be set up to convey the first MEA component as web material or as several MEA component sections of the first MEA component, and/or to fix/hold it by means of a vacuum. The second transport apparatus can convey the first MEA component freely, in particular under tension.

The second conveying speed can be different from the first conveying speed and/or from a third conveying speed of a third transport apparatus in the form of a vacuum conveyor belt. In particular, the conveying speed of the second transport apparatus can be lower than the conveying speed of the first and/or third transport apparatus. The conveying speed of the first transport before apparatus and/or the conveying speed of the third transport apparatus can be higher than the conveying speed of the second transport apparatus. The second transport apparatus can be set up to transfer or forward the first MEA component and/or MEA component sections of the first MEA component to the first transport apparatus or to the third transport apparatus without interrupting a, in particular continuous, conveyance of the first MEA component and/or the MEA component sections of the first MEA component.

One advantage of this is that the distance between the MEA component sections can be varied, be or increased due to the different conveying speeds of the transport port apparatuses, while the MEA component sections are conveyed uninterruptedly and/or continuously and/or transferred between the transport apparatuses at the different conveying speeds. Manufacturing does not have to be interrupted and/or slowed down to vary or increase the distances between the component sections. Varying or increasing the distances between the component sections using two transport apparatuses and/or vacuum conveyor belts is also advantageous because the MEA component sections can be produced on the second transport apparatus, for example by cutting or splitting a web material, and can then be further processed on the first or third transport apparatus without interrupting manufacturing. Varying or increasing the distance between the MEA component sections also allows processing steps to be performed on the MEA component sections that would not be possible with directly adjacent MEA component sections, for example immediately after cutting the first MEA component provided as web material.

Optionally, the apparatus can further comprise a transfer apparatus, for example a gripper or vacuum gripper, which is set up to move the MEA component sections of the first MEA from the second transport apparatus to the first or third transport apparatus. However, this is expressly not necessary in all embodiments; the movement of the MEA component sections of the first MEA from the second transport apparatus to the first or third transport apparatus can also be carried out directly by the transport apparatuses themselves and without a separate transfer apparatus. The movement of the MEA component sections of the first MEA from the second transport apparatus to the first or third transport apparatus can take place continuously.

Optionally, an inspection apparatus can be set up and designed to detect a property defect and/or an arrangement error in the MEA components and/or MEA component sections conveyed by the transport apparatus(s). In the event that a property defect and/or an arrangement error is detected, an MEA component or an MEA component section can be excluded from further manufacturing, for example by conveying the defective MEA components and/or MEA component sections to a reject pick-up or depositing apparatus.

A method of manufacturing a membrane electrode assembly, MEA, comprises at least the steps of:
conveying, with a first transport apparatus, at least a first carrier frame with a first conveying speed; and
arranging, with a first arranging apparatus in the form of a vacuum drum, at least one membrane on the at least one carrier frame while it is being conveyed by the first transport apparatus; and
arranging, with a second arranging apparatus in the form of a vacuum drum, of at least a second carrier frame on the membrane, while the latter is conveyed together with the first carrier frame by the first transport apparatus.

The at least one first carrier frame can be provided together with a first carrier layer, wherein the at least one first carrier frame can be fixed to the first carrier layer with an adhesive application, in particular a full-surface and/or heat-soluble adhesive application. The at least one second carrier frame can be provided together with a second carrier layer, wherein the at least one second carrier frame can be fixed to the second carrier layer with an adhesive application, in particular a full-surface and/or heat-soluble adhesive application.

In a variant, at least one first recess can be made in the first carrier frame while it is fixed to the first carrier layer, for example with a rotary die cutter. Furthermore, at least one first recess can optionally be made in the second carrier frame while it is fixed to the second carrier layer, for example with a rotary die cutter.

Optionally, the method of manufacturing a membrane electrode assembly, MEA, may further comprise at least one of the following steps:
detaching the at least one first carrier frame from the first carrier layer;
detaching the at least one second carrier frame from the second carrier layer;
Heating the first and/or second carrier frame and a full-surface and/or heat-soluble adhesive application set up on the first and/or second carrier frame;
arranging a first MEA component, in particular a gas diffusion layer, GDL, on the first or the second carrier frame and/or arranging a second MEA component, in particular a GDL, on the first or the second carrier frame;
inserting further recesses into the first carrier frame and/or into the second carrier frame, in particular with a rotary punch, the further recesses being set up in particular adjacent to one or more outer edges of the first recess.

### BRIEF DESCRIPTION OF THE DRAWINGS

Further features, properties, advantages and possible modifications will become clear to a person skilled in the art from the following description, in which reference is made to the accompanying drawings. The figures show schematic examples of a membrane-electrode arrangement and a manufacturing apparatus for a membrane-electrode arrangement.

FIG. 1 shows an example of a carrier frame and a membrane electrode assembly, MEA.

FIG. 2 shows an example of a carrier frame with an adhesive applied to it.

FIGS. 3-7 each show examples of apparatuses for manufacturing a membrane electrode arrangement.

### DETAILED DESCRIPTION OF THE EMBODIMENTS

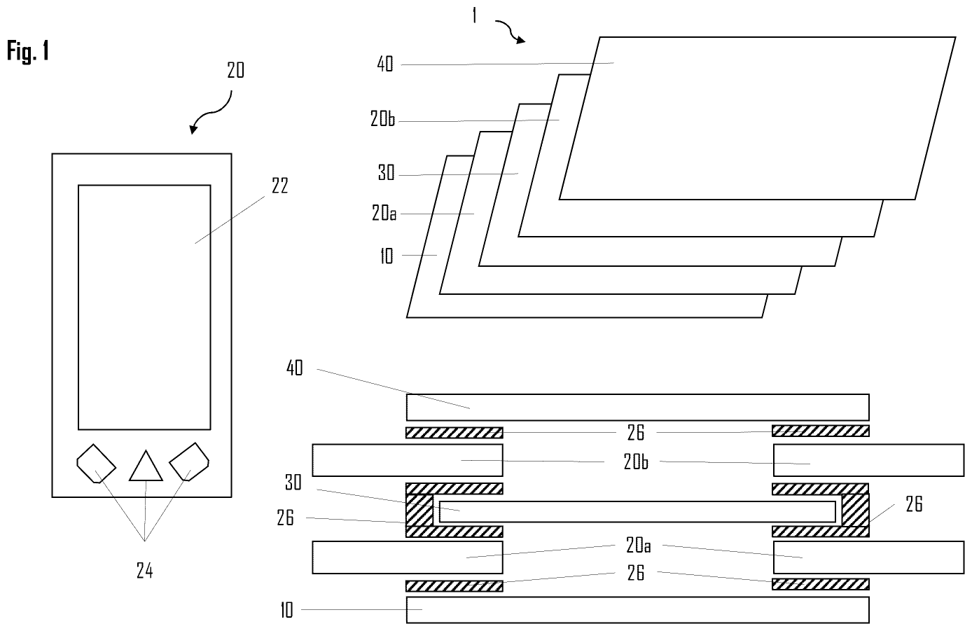

Unless explicitly stated otherwise, components and parts in the schematic FIGS. 1 to 7 that correspond or are comparable in their function are provided with reference symbols that correspond to each other.

FIG. 1 shows a carrier frame 20 for a membrane electrode arrangement 1. The carrier frame 20 has a first recess 22 and several further recesses 24. The further recesses 24 can be set up adjacent to one or more outer edges of the first recess 22. In other words, the further recesses 24 can be set up completely on one side next to the first recess 22 or surround the recess 22 from several sides. In the example shown, the carrier frame 20 is already separated from a web material comprising several carrier frames, namely a carrier web. However, this is not absolutely necessary for the manufacturing of a membrane electrode assembly, MEA. Rather, several membrane electrode assemblies can alternatively be manufactured on a continuous carrier web material with several carrier frames and then separated from each other. Sections of a component originally provided as a quasi-infinite web material for a membrane electrode assembly that are separated from each other are component sections.

Furthermore, FIG. 1 schematically shows the structure of a membrane electrode arrangement 1 to be manufactured. The membrane electrode arrangement 1 comprises the first carrier frame 20a with the first recess 22. The first recess 22 is molded by an adhesive application 26, which is applied to the carrier frame 20a. A catalyst-coated membrane 30 and a second carrier frame 20b, a further adhesive application 26 and a gas diffusion layer, GDL, 40 are set up on the carrier frame 20a with the adhesive application 26. The catalyst-coated membrane 30 and the second carrier frame 20b are attached to each other by the adhesive application 26 set up between these components. The GDL 40 is attached to the second carrier frame 20b by the adhesive application 26 set up between these components. In the example shown, the gas diffusion layer 40 is a cathode of a membrane electrode arrangement 1. A further adhesive application 26 and a further GDL 10, in this case an anode, are set up on the surface of the first carrier frame 20a facing away from the cathode 40. In the example shown, the cathode 40 and the anode 10 are each designed as layer electrodes. In other variants not shown, the GDL 40 can form an anode and the GDL 10 can form a cathode. In other words, the anode and the cathode of the arrangement shown can be interchanged without any further structural change to the membrane electrode arrangement 1.

In the following, the embodiments shown in FIG. are therefore described with an arranging cathode 40 and anode 10, whereby it is clear that the cathode 40 and the anode 10 are each a GDL and that the anode and cathode can be exchanged with each other as corresponding elements without changing the structure of the apparatuses shown in the FIGS. beyond the exchange of cathode and anode.

The first support frame 20a and the second support frame 20b are identically shaped in the illustrated embodiment example of the membrane electrode arrangement 1 and each have identically shaped and identically set up recesses 22, 24. The first carrier frame 20a and the second carrier frame 20b are set up one above the other in such a way that the respective recesses 22, 24 in the carrier frames are located opposite each other, where the membrane 30 covers or covers at least the first recess 22 in the first and in the second carrier frame.

As shown in FIG. 1, the catalyst-coated membrane 30 may be disposed between the support frames 20a, 20b, wherein the adhesive application 26 disposed between the support frames 20a, 20b may serve both to secure or fix the adhesive frames to each other and to secure or fix the membrane 30 to the support frames 20a, 20b.

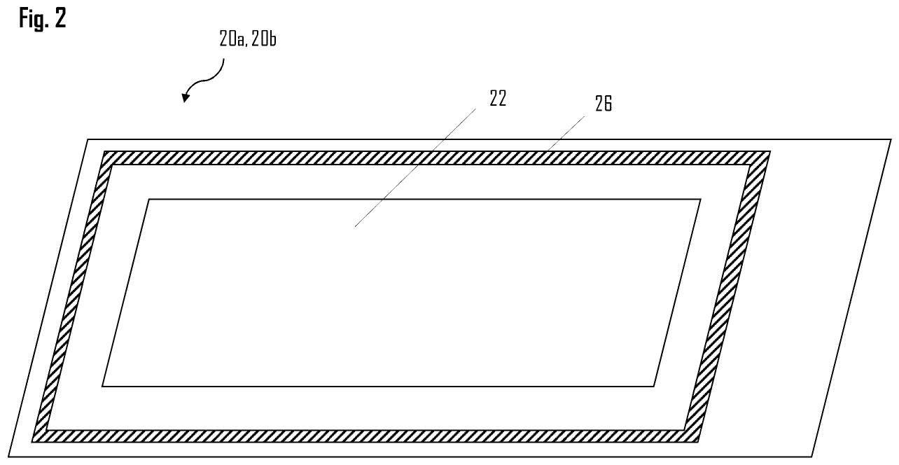

FIG. 2 shows an example of a carrier frame 20a, 20b with a first recess 22 and an adhesive application 26 applied to the carrier frame 20a, 20b in the form of an adhesive frame which completely encompasses the first recess 22, in a schematic table perspective view. Other examples of carrier frames 20a, 20b not shown may also have further recesses. The first recess 22 of the carrier frame 20a, 20b shown can, for example, be produced using a punching process or a milling process.

In alternative embodiments, not shown, the adhesive application can also be applied over the full area of one or both carrier frames 20a, 20b, whereby the adhesive application 26 applied over the full area of the carrier frame(s) 20a, 20b in this case also completely encompasses or encloses at least the first recess 22 in the carrier frame 20a, 20b.

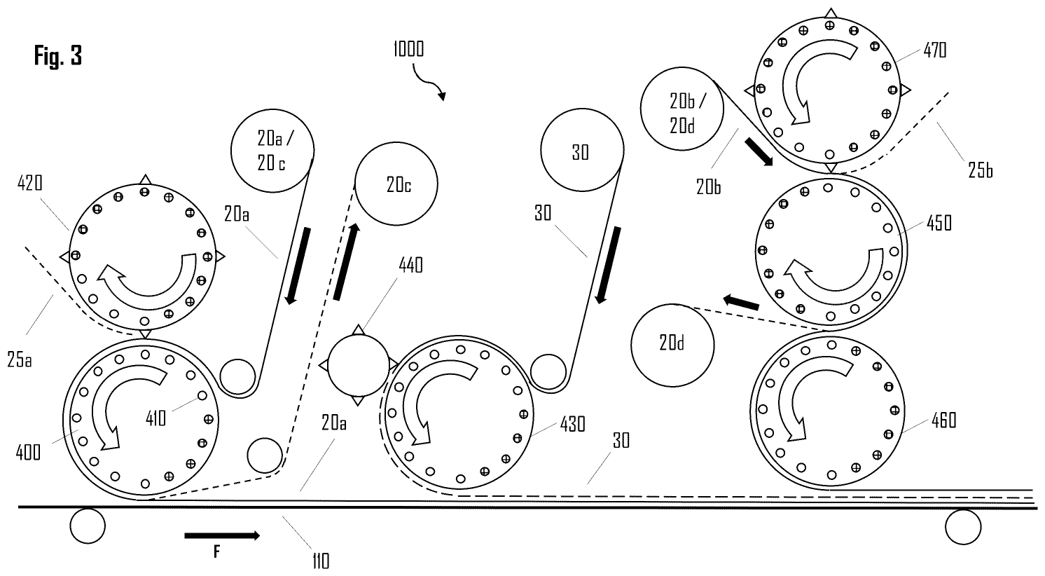

FIG. 3 shows an example of the arranging a membrane 30 for a membrane electrode arrangement on a first support frame 20a, wherein the first support frame 20a is provided as a continuous and quasi-infinite web material from a roll of web material. In other words, the quasi-infinite web material provided by the roll comprises a plurality of support frames 20a which are not yet separated or isolated from each other.

In the example shown, the first carrier frame 20a is provided as a continuous and quasi-infinite web material together with a first carrier layer 20c, wherein the first carrier frame 20a is fixed with a full-surface heat-soluble adhesive application to the carrier layer 20c, which is also provided as a continuous web material.

The first carrier frames 20a provided are conveyed together with the first carrier layer 20c to a vacuum drum 400 and fixed by the latter by means of negative pressure and, by rotating the vacuum drum 400, are continuously conveyed further along a circular path or a circular path section.

The vacuum drum 400 has several openings 410. The openings 410 are located in the lateral surface of the vacuum drum 400 and are only shown schematically in the FIGS. for reasons of clarity. The vacuum drum 400 is designed to generate a vacuum pressure and to fix the first carrier frame 20a and/or the first carrier layer 20c on its lateral surface and to convey them without slippage. The generated negative pressure can be selectively activated or deactivated for each of the openings 410. In other words, a negative pressure generated by the vacuum drum 400 can be applied for each individual opening 410 and then neutralized or cancelled again, whereby the application and cancellation of the negative pressure for each of the openings 410 can occur independently of the respective other openings. Optionally, the openings 410 can be selectively closed or opened for this purpose, but this is not necessary in all embodiments.

By rotating about a first axis of rotation, the vacuum drum 400 conveys the first carrier frames 20a to a rotary punching press 420, which is set up to punch at least one first recess 22 into each of the first carrier frames 20a provided as continuous web material. In other embodiments not shown, the carrier frames provided as web material can also already be provided with one or more recesses. The rotary die cutter 420 introduces the first recesses 22 into the first carrier frames 20a while these are set up on the first carrier layer 20c.

Furthermore, FIG. 3 shows that the rotary punching press 420 itself is at least partially designed as a vacuum drum. The rotary die-cutter 420 also has several openings. The openings are located in the lateral surface of the rotary die-cutter 420 and are only shown schematically in FIG. 3 for reasons of clarity. The rotary punching press 420 is designed to generate a vacuum and to fix material sections 25a punched out of the first carrier frame 20a on its lateral surface and to convey them away from the vacuum drum 400. The generated negative pressure can be selectively activated or deactivated for each of the openings. In other words, a negative pressure generated by the rotary punching press 420 can be applied for each individual opening and then neutralized or cancelled again, whereby the application and cancellation of the negative pressure for each of the openings can take place independently of the respective other openings. Optionally, the openings can be selectively closed or opened for this purpose, but this is not necessary in all embodiments.

In the example shown, the vacuum drum 400 is a heatable vacuum drum which heats the full-surface heat-soluble adhesive application between the first carrier frames 20a and the first carrier layer 20c and thereby loosens it, so that the fixation of the first carrier frames 20a to the first carrier layer 20c is cancelled or released.

An advantage of the at least partial design of the rotary punching press 420 as a vacuum drum is that material sections 25a punched out of the first carrier frames 20a, which can be produced, for example, during the manufacture of the first recesses 22, can be detached from the vacuum drum 400 and transported away by the rotary punching press 420. Activation or deactivation of the negative pressure, which acts on the material sections 25a through the individual openings in the vacuum drum 400 and in the rotary punching press 420, can be coordinated in such a way that the material sections 25a are released from the vacuum drum 400 and fixed by the rotary punching press 420. The vacuum drum 400 and the rotary die-cutter 420, in particular their rotation speeds and/or their vacuum generation, can be controlled or regulated for this purpose by a common control or regulation system.

Furthermore, in the example shown in FIG. 3, the vacuum drum 400 is set up to convey the first carrier frames 20a, which are each provided with a first recess 22, to a transfer position and to arrange the first carrier frames 20a provided as quasi-infinite web material at this transfer position on a first transport apparatus 110. In order to arrange the first carrier frames 20a on the first transport apparatus 110, the negative pressure which fixes the first carrier frames 20a to a lateral surface of the vacuum drum 400 is cancelled. The heating of the full-surface heat-soluble adhesive application between the first carrier frames 20a and the first carrier layer 20c enables the first carrier frames 20a to be detached from the first carrier layer 20c.

In the example shown in FIG. 3, the openings 410 in the outer surface of the vacuum drum 400 are closed when the vacuum is released or neutralized. For a renewed fixing of the continuously fed carrier frames 20a and/or the carrier layer 20c, the respective openings 410 can be reopened and/or activated after a rotation of the vacuum drum 400 by a certain angle. However, both are expressly not necessary in all embodiments. Further, the vacuum drums shown in FIG. 3 may have an adhesion-reducing coating on their peripheral surface/surface, for example a Teflon coating. In other embodiments, the vacuum drums may also have a rubber or plastic coating on their outer surface and/or be at least partially made of a rubber or plastic material.

After the first carrier frames 20a have been detached from the first carrier layer 20c, the first carrier layer 20c is conveyed to a first carrier layer receiving apparatus in the form of a carrier layer roller. The carrier layer receiving apparatus is set up to receive the first carrier layer 20c after the first carrier frames 20a have been detached from it.

In the example shown in FIG. 3, the first transport apparatus 110 is a vacuum conveyor belt, which is set up to convey the first carrier frames 20a to a first arranging apparatus with a vacuum drum 430. The vacuum drum 430 and the vacuum drum 400 are designed to correspond to one another, with the vacuum drum 430 being set up for fixing and conveying a membrane 30.

Optionally, the first support frames 20a can each be coated with an adhesive application 26 by an adhesive application apparatus (not shown) while the first support frames 20a are conveyed by the first transport apparatus 110. The adhesive application can be used to attach or fix the membrane 30 and/or one or more second support frames 20b to/on the first support frame 20a. Optionally, a further application of adhesive 26 can also be applied to the membrane 30 while it is being conveyed, wherein this further application of adhesive can serve to fasten or fix the membrane 30 to/on the first and/or the second carrier frame.

The membrane 30 is provided as continuous web material from a web material roll and conveyed to the vacuum drum 430 of the first arranging apparatus. By rotating about an axis of rotation, the vacuum drum 430 conveys the membrane 30 to a cutting apparatus 440, which is set up to cut or separate the membrane 30 provided as web material into a plurality of membrane sections or MEA component sections. In other embodiments, not shown, the membrane 30 can also be provided in the form of already separated or separated membrane sections.

Furthermore, in the example shown in FIG. 3, the vacuum drum 430 is set up to convey the divided or cut membrane 30 to a transfer position and to arrange it there on the first carrier frames 20a, which are each conveyed by the first transport apparatus 110. The vacuum drum 430 can arrange a respective membrane 30 on a respective first carrier frame 20a. In particular, the vacuum drum 430 can arrange a membrane 30 on a respective first carrier frame 20a in such a way that the first recess 22 in the first carrier frame 20a is covered or closed in each case. In order to attach the membrane 30 to the first carrier frame 20a, the pressure that fixes the membrane 30 to the outside of the vacuum drum 430 is cancelled.

After the cut membrane 30 has been set up on the first carrier frame 20a, it is conveyed together by the first transport apparatus 110 to a second arranging apparatus with a vacuum drum 460.

The second arranging apparatus with the vacuum drum 460 is set up to arrange a second carrier frame 20b provided as continuous web material on the first carrier frame 20a conveyed as continuous web material by the first transport apparatus 100 and the membrane 30 set up thereon. The vacuum drum 460 and the vacuum drum 400 are designed to correspond to one another, wherein the vacuum drum 460 detaches or takes over the second carrier frames from a further vacuum drum 450 before it arranges them on the carrier frame 20a with the membrane 30.

The second carrier frames 20b are provided as continuous web material together with a second carrier layer 20d and conveyed to the further vacuum drum 450. The second carrier frames 20b are each set up with a full-surface heat-soluble adhesive application on the second carrier layer 20d. The further vacuum drum 450 is also designed to correspond to the vacuum drum 400. The further vacuum drum 450 conveys the carrier frames 20b provided as web material together with the second carrier layer 20d to a rotary die cutter 470, which is also designed as a vacuum drum corresponding to the rotary die cutter 420. The rotary punching press 470 makes a first recess 22 in each of the second carrier frames 20b and removes the punched-out material sections 25b from the lateral surface of the vacuum drum 450. Like the vacuum drum 400, the vacuum drum 450 is also a warmable or heatable vacuum drum, which heats the full-surface heat-soluble adhesive application between the second carrier frames 20b and the second carrier layer 20d and thereby cancels or releases the fixation of the second carrier frames 20b to the second carrier layer 20d.

The vacuum drum 450 then conveys the second carrier frames 20b to the vacuum drum 460 of the second arranging apparatus. At a transfer point between the vacuum drums 450, 460, the vacuum drum 450 neutralizes a vacuum, with which it fixes the second carrier frames 20b and the second carrier layer 20d to their lateral surface. At the same time, the vacuum drum 460 takes over the second carrier frames 20b from the vacuum drum 450 and/or from the second carrier layer 20d by generating a negative pressure through the openings in the jacket surface, which acts on the second carrier frames 20b.

After the second carrier frames 20b have been detached from the second carrier layer 20d, the first carrier layer 20b is conveyed to a second carrier layer receiving apparatus in the form of a carrier layer roller. The carrier layer receiving apparatus is set up to receive the second carrier layer 20d after the second carrier frames 20b have been detached from it.

The vacuum drum 460 of the second arranging apparatus conveys the second carrier frames 20b to a transfer point and arranges the second carrier frames 20b on the first carrier frame 20a and the membrane 30 in such a way that the first recesses 22 of the respective carrier frames 20a, 20b are set up one above the other. In order to arrange the second carrier frames 20b on the first carrier frame 20a with the membrane 30, the negative pressure which fixes the first carrier frames 20b to a lateral surface of the vacuum drum 460 is cancelled.

This results in a membrane-electrode arrangement with a first carrier frame 20a, a membrane 30 and a first carrier frame 20b, which is further conveyed by the first transport apparatus 110. This arrangement can subsequently be fed to a curing station for curing the adhesive application 26 (not shown) and/or a pressing apparatus, for example a cold lamination station with pressing or lamination rollers (not shown).

Furthermore, the arrangement produced by the apparatus shown in FIG. 3 with a first carrier frame 20a, a membrane 30 and a first carrier frame 20b can be transferred to another, in particular third, transport apparatus (not shown) and/or fed to further manufacturing or processing. For example, the first and second carrier frames 20a, 20b, which are designed as continuous web material, together with the membrane 30 set up between them can be conveyed further by the first transport apparatus to a cutting apparatus (not shown), which divides or cuts the membrane-electrode arrangement into a plurality of sections, each of which has a separated or separated first carrier frame 20a, a membrane section 30 and a separated or separated second carrier frame 20b.

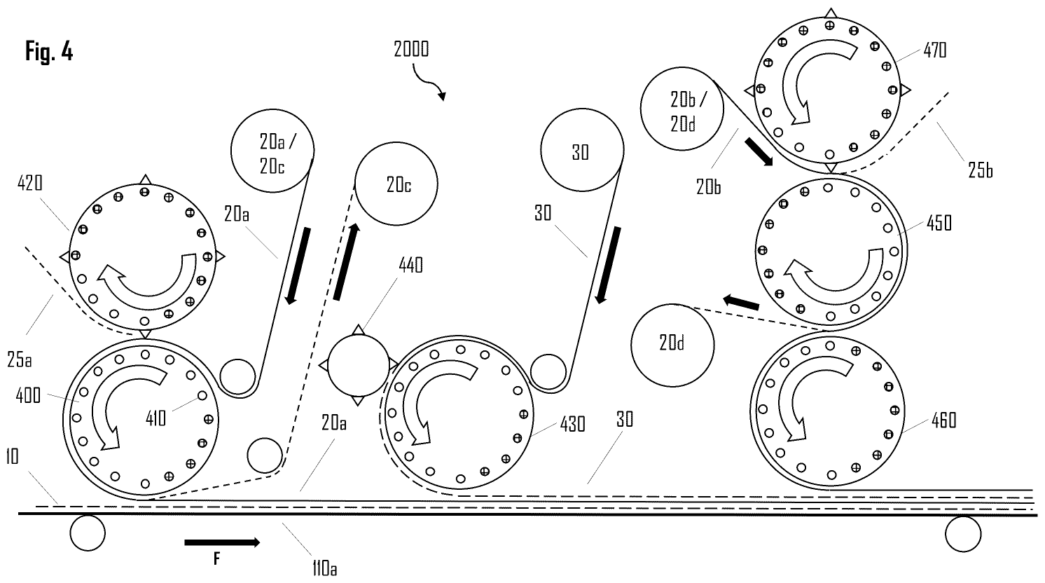

FIG. 4 shows a further development 2000 of the apparatus 1000 shown in FIG. 3. Instead of the first transport apparatus 110, FIG. 4 shows the first transport apparatus 110a. Like the transport apparatus 110 shown in FIG. 3, the first transport apparatus 110a is a vacuum conveyor belt. In contrast to the apparatus shown in FIG. 3, however, the first transport apparatus 110a conveys an anode/GDL 10 in the form of individual and spaced-apart component sections. In other words, the first transport apparatus 110a conveys several separated sections of an anode/GDL 10 in the conveying direction F.

In the example shown in FIG. 4, the first vacuum drum 400 is set up to arrange the first carrier frames 20a on a respective MEA component section, namely on a section of the anode/GDL 10. In particular, the first vacuum drum 400 can arrange the first support frames 20a on the respective sections of the anode/GDL 10 such that the first recess in the first support frames is completely covered or closed by the sections of the anode/GDL 10 in each case.

Furthermore, the example shown in FIG. 4 for an apparatus for manufacturing membrane electrode arrangements is identical to the example shown in FIG. 3 for an apparatus for manufacturing membrane electrode arrangements. However, since the first support frames are already set up on an anode/GDL 10, in the example shown in FIG. 4 an arrangement with an anode/GDL 10, a first support frame 20a, a membrane 30 and a second support frame 20b is manufactured. Optionally, a cathode/GDL 40 can also be added to this arrangement, for example with an additional arranging apparatus with a vacuum drum (not shown), which arranges a cathode/GDL 40 on the second carrier frame 20b after it has been set up on the first carrier frame 20a and the membrane 30. An adhesive application or adhesive frame can be set up or applied beforehand on the cathode/GDL 40 and/or on the carrier frame 20b, which serves to fasten or fix the cathode/GDL 40 on the carrier frame 20b or at least supports it. In this way, the membrane electrode arrangement 1 shown in FIG. 1 can be produced. Subsequently, the first and second carrier frames 20a, 20b formed as a continuous web material with the other MEA components, namely with the anode/GDL 10, the membrane 30 and/or the cathode/GDL 40, can be conveyed further by the first transport apparatus 110a to a cutting apparatus (not shown), which divides or cuts the membrane electrode assembly 1 into several sections.

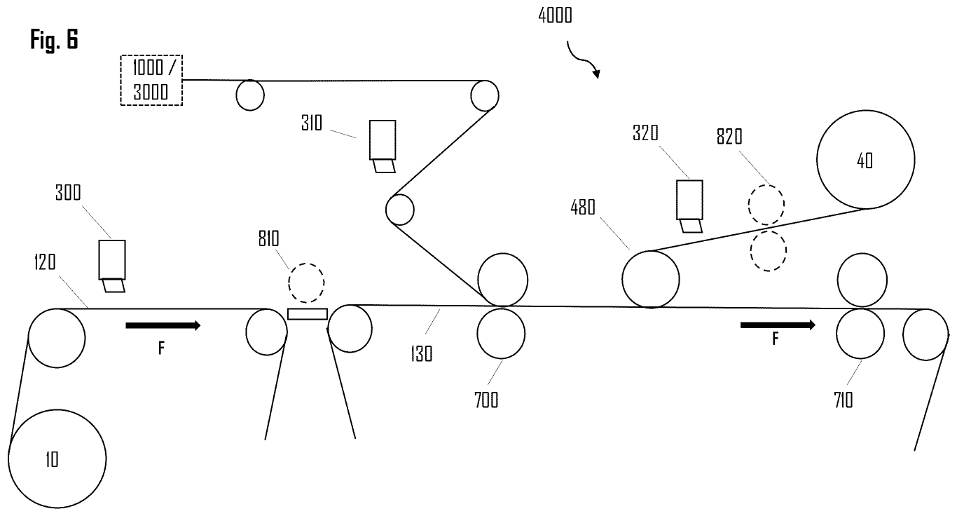

In a variant, the first transport apparatus 110a can take over the sections of the anode/GDL 10 from another transport apparatus before the first carrier frames 20a are respectively set up on the sections of the anode/GDL 10, wherein the first transport apparatus 110a can convey the sections of the anode/GDL 10 at a higher speed than the transport apparatus from which it respectively takes over the sections of the anode/GDL 10. One advantage of this is that the distances between the sections of the anode/GDL 10 can be increased as a result. In particular, this makes it possible to arrange the first carrier frames 20a on the sections of the anode/GDL 10 in such a way that the first carrier frames 20a protrude over the respective sections of the anode/GDL 10 in the conveying direction and/or against the conveying direction. The transfer of MEA component sections from one transport apparatus to another transport apparatus with a higher conveying speed is explained in more detail below with reference to FIG. 6.

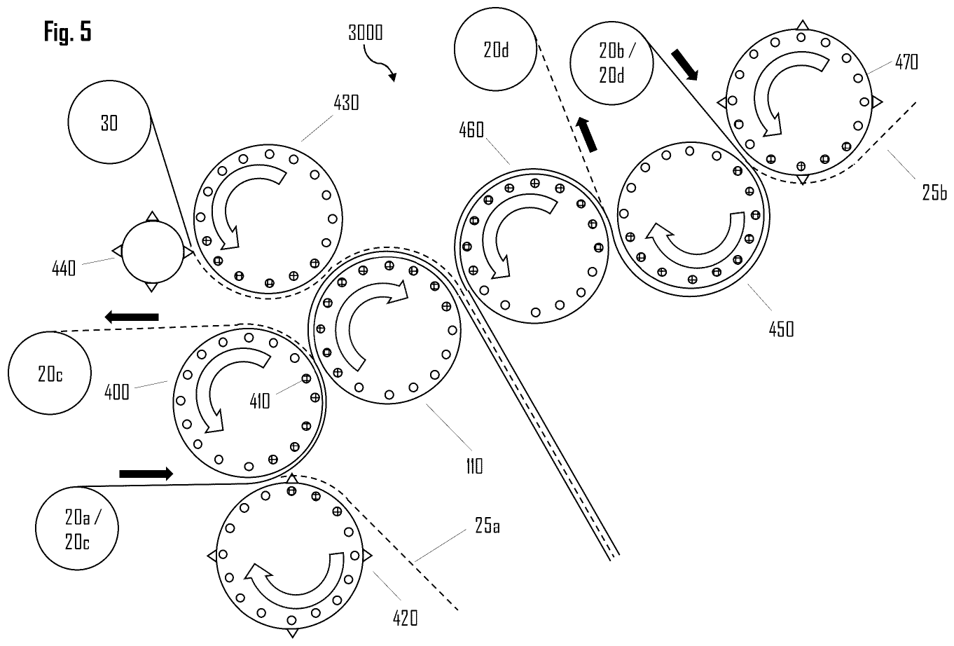

FIG. 5 shows an alternative 3000 to the apparatus 1000 shown in FIG. 3. In contrast to the apparatus shown in FIG. 3, in the example shown in FIG. 5 the first transport apparatus 110 itself is designed as a rotatable vacuum drum. The rotatable vacuum drum, which forms the transport apparatus 110, is designed to correspond to the vacuum drum 400.

The design of the first transport apparatus 110 as a vacuum drum allows a particularly compact design of the apparatus for manufacturing a membrane electrode arrangement on one hand, while at the same time the precision of the arranging the MEA components on the first transport apparatus 110 can be further improved compared to the example shown in FIG. 3. Rolling or pressing the MEA components onto the first transport apparatus 110 is further improved compared to the example shown in FIG. 3 by the fact that the surface or lateral surface of a vacuum drum can be made less elastic than that of a vacuum conveyor belt. Furthermore, the MEA components are subjected to lower material stresses when transferring from a curved surface of a vacuum drum to the curved surface of another vacuum drum than when transferring from a curved surface of a vacuum drum to a flat surface of a vacuum conveyor belt.

A further advantage of the arrangement shown in FIG. 5 is that an undesired offset between the first carrier frame 20a and the second carrier frame 20b can be better counteracted and an otherwise necessary alignment of the carrier tracks transverse to the conveying direction can be omitted.

Furthermore, the vacuum drums and/or rotary punching presses and/or cutting apparatuses shown in FIG. 5 may comprise a common drive for the rotational movements of the vacuum drums and/or rotary punching presses and/or cutting apparatuses and/or a common regulation or control for the rotational movements of the vacuum drums and/or rotary punching presses and/or cutting apparatuses. In other words, all of the vacuum drums and/or rotary punching presses and/or cutting apparatuses shown in FIG. 5, expressly including the vacuum drum of the first transport apparatus 110, or at least some of the vacuum drums and/or rotary punching presses and/or cutting apparatuses shown in FIG. 5 may be rotated by a common drive. The circumferential speeds of the vacuum drums and/or rotary punching presses and/or cutting apparatuses can be the same or different from one another. This simplifies synchronization of the rotational movements of the vacuum drums and enables a further increase in the manufacturing precision of the apparatus for manufacturing the membrane electrode assembly. In particular, so-called “wrinkling” of the first carrier frame 20a and second carrier frame 20b provided as web material can thus be prevented or at least reduced.

In a variant, at least the vacuum drums 110, 400, 450 and 460 and/or the rotary punching presses 420 and 470 can have a common drive or be driven by a first common drive. The vacuum drum 430 and the cutting apparatus 440 may have a second common drive or may be driven by a second common drive. The peripheral speeds of the vacuum drums and/or rotary punching presses and/or cutting apparatuses may be the same or different from one another.

Furthermore, the example shown in FIG. 5 for an apparatus for the manufacturing of membrane electrode arrangements is identical to the example shown in FIG. 3 for an apparatus for the manufacturing of membrane electrode arrangements. In particular, the apparatus shown in FIG. 5 also manufactures an arrangement with at least one first carrier frame 20a, a membrane 30 and at least one second carrier frame 20b, wherein the carrier frames 20a, 20b are each in the form of a continuous web material and can be cut or divided into a plurality of individual MEA component sections using a further manufacturing station (not shown).

In a further embodiment, not shown, the manufacture of membrane-electrode arrangements, a further rotary punching press can be designed and set up to introduce further recesses 24, in particular in the conveying direction before and after a respective recess 22, into the first carrier frame 20a and/or into the second carrier frame 20b, while these are conveyed together with the membrane 30 set up between them by the first transport apparatus 110 and/or by the vacuum drum 460. The further recesses 24 can completely penetrate both the first carrier frames 20 and the second carrier frames 20b, wherein the membrane 30 in each case covers or closes the first recess 22 in the carrier frames 20a, 20b, but does not cover or close and/or is tangent to the respective further recesses 24. In particular, the further rotary punching press can be driven by the first common drive. The vacuum drum 460 or the first transport apparatus 110 can form a counter bearing for the further rotary punch. One advantage of introducing the further recesses 24 in this way is that the further recesses 24 can be manufactured to fit each other precisely.

FIG. 6 shows a further development 4000 of the apparatuses 1000, 3000 shown in FIG. 3 and FIG. 5 for manufacturing a membrane electrode arrangement.

In the example shown in FIG. 6, an anode/GDL 10 is provided as a continuous quasi-un finite roll material and is continuously conveyed in the conveying direction F by a second transport apparatus 120, which is a vacuum conveyor belt.

In a first processing step, a first application apparatus 300 applies an adhesive to the anode/GDL 10. The adhesive composition of the adhesive applied to the anode/GDL 10 can correspond to an adhesive composition for the carrier frames 20a, 20b, which is used for fastening or fixing the carrier frames to one another and/or for fastening or fixing the membrane to the carrier frames 20a, 20b.

The continuous conveying of the anode/GDL 10 by the second transport apparatus 120 is not interrupted during the application of the adhesive by the first application apparatus 300. The adhesive application can in particular be an adhesive that hardens under UV light, pressure and/or heat. In a variant of the apparatus for manufacturing membrane electrode assemblies that is not shown, the apparatus can also have a UV curing station that is set up to at least partially cure the adhesive application by means of UV light.

The anode/GDL 10 is then conveyed to a first cutting apparatus 810, which is set up to cut the first MEA component provided as web material, in this case the anode 10 in the form of a GDL, into several MEA component sections.

In the example shown, the first cutting apparatus 810 has a cutting cylinder that interacts with a cutting support, in this case a cutting table/cutting anvil, over which the MEA components are guided for cutting. In the example shown, the MEA components are conveyed onto and over the cutting support by the second transport apparatus 120.

The MEA component sections are then set up or transported from the second transport apparatus 120 and/or the cutting support onto the third transport apparatus 130. In the example shown, the third transport apparatus 130 is also a vacuum conveyor belt. The third transport apparatus 130 has a distance of approximately 1 cm from the second transport apparatus 120, so that the MEA component sections can be fed directly from the second transport apparatus 120 to the third transport apparatus 130 via the cutting support. In other embodiments not shown, however, any other spacing between the third and two transport apparatuses can also be realized, whereby these embodiments not shown can have all the other features of the embodiment shown here. In further embodiments not shown, the apparatus can also have, for example, a vacuum gripper that removes the MEA component sections from the second transport apparatus 120 and arranges them on the third transport apparatus 130. However, this is expressly not necessary in all embodiments.

Furthermore, the vacuum transport belt of the second transport apparatus 120 can optionally also cancel or neutralize a negative pressure with which the MEA component sections are fixed during conveying in the conveying direction F, in order to enable or facilitate the arrangement or transport tie ren of the MEA component sections from the second transport apparatus 120 to or onto the third transport apparatus 130.

The third transport apparatus 130 conveys the MEA component sections at a higher speed than the second transport apparatus 120. This increases the distance between the MEA component sections conveyed in each case, so that further component or component sections can now also be set up on the s which protrude beyond the previously manufactured MEA component sections in the conveying direction F or which are larger than the previously manufactured MEA component sections.

In the example shown in FIG. 6, an MEA component arrangement with a first carrier frame 20a, a membrane 30 and a second carrier frame 20b is set up on the spaced-apart MEA component or sections conveyed by the third transport apparatus 130, in this case the sections of the anode/GDL 10 separated from one another, with the carrier frames 20a, 20b projecting beyond the MEA component sections in the conveying direction F in each case. An MEA component arrangement with a first carrier frame 20a, a membrane 30 and a second carrier frame 20b is set up on each section of the anode/GDL 10, with the sections of the anode/GDL 10 each covering or closing at least one first recess in one of the carrier frames 20a, 20b. In the example shown in FIG. 6, the support frames 20a, 20b are not yet separated or separated from each other at the time of arrangement on the sections of the anode/GDL 10.

To improve the fixation of the anode/GDL 10 to the MEA component arrangement, an adhesive application is applied to the first or second carrier frame with a second application apparatus 310 before the arrangement. In particular, the adhesive application may be a frame-like adhesive application or adhesive frame that encloses an adhesive-free area on the anode/GDL 10 and/or surrounds or encompasses a recess 22 in the first or second carrier frame in a frame-like manner. In other embodiments not shown, embodiments an adhesive application can alternatively or additionally be applied to the anode/GDL 10. In particular, the adhesive application can be an adhesive that hardens under UV light, pressure and/or heat. In a variant of the shown apparatus for manufacturing membrane electrode assemblies that is not shown, the apparatus can also have a UV curing station that is set up to at least partially cure the adhesive application using UV light. In a variant, not shown, of the apparatus shown for the manufacturing of membrane electrode assemblies, this apparatus can furthermore have a UV curing station which is set up to at least partially cure the adhesive application by means of UV light.

The MEA component arrangement, which comprises an anode/GDL 10, a first carrier frame 20a, a membrane 30 and a second carrier frame 20b, is then guided through the third transport apparatus 130 to a lamination apparatus 700. The lamination apparatus 700 is a roller lamination apparatus that presses the MEA components together.

After the lamination apparatus 700 has pressed the anode/GDL 10, the first carrier frame 20a, the membrane 30 and the second carrier frame 20b together, a fifth MEA component, namely a cathode/GDL 40, is set up on the MEA component arrangement.

The cathode/GDL 40 is first provided as a continuous web material and then cut or separated into several MEA component sections by a second cutting apparatus 820 with a cutting cylinder. An adhesive is then applied to the cathode/GDL 40 using a third application apparatus 320.

The cathode/GDL 40 can be conveyed by a fourth transport apparatus (not shown) during cutting/dividing and during the application of the adhesive. Continuous conveying of the cathode/GDL 40 by the fourth transport apparatus need not be interrupted during application of the adhesive by the second application apparatus 320. The adhesive application can in particular be an adhesive that hardens under UV light, pressure and/or heat. In a variant, not shown, of the apparatus for manufacturing membrane electrode assemblies shown, this apparatus can also have a UV curing station which is set up to at least partially cure the adhesive application by means of UV light.

Furthermore, the apparatus 4000 has an additional arranging apparatus 480, which in a variant can also be a vacuum drum designed to correspond to the vacuum drum 400, which in each case arranges an MEA component section, namely an isolated section of the cathode/GDL 40, on the MEA component arrangement conveyed by the third vacuum conveyor belt 130 with the carrier frames 20a, 20b, the membrane 30 and the anode/GDL 10.

The sections of the cathode/GDL 40 are each set up on one of the carrier frames 20a, 20b by the additional arranging apparatus 480 in such a way that the at least first recess 22 in one of the carrier frames 20a, 20b is closed or covered on a side of the MEA component arrangement that is above or away from the anode/GDL 10 with respect to.

The MEA component arrangements, which now each comprise a cathode/GDL 40, a first carrier frame 20a, a membrane 30, a second carrier frame 20b and an anode/GDL 10, are then transported by the third transport apparatus 130 to a further lamination apparatus 710. The further lamination apparatus 710 is a roller lamination apparatus that presses the MEA components against each other.

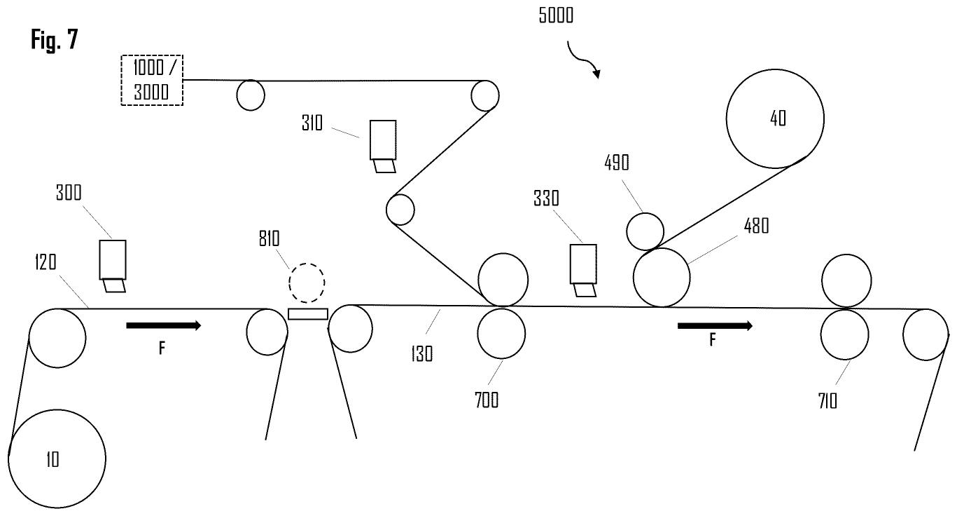

FIG. 7 shows an alternative further development 5000 of the apparatuses 1000, 3000 shown in FIG. 3 and FIG. 5 for manufacturing a membrane electrode arrangement.

In contrast to the further development 4000 shown in FIG. 6, the cathode/GDL 40 provided as web material is fed without prior cutting to the additional arranging apparatus 480, which may for example be a vacuum drum designed to correspond to the vacuum drum 400, and is fixed by the latter. The cutting or dividing of the cathode/GDL 40 provided as web material takes place while it is conveyed along a circular path or along a circular path section by the additional arranging apparatus 480, by means of an additional cutting apparatus or rotary punching press 490.

Furthermore, in the example shown in FIG. 7, no adhesive is applied to the cathode/GDL 40. Instead, the apparatus shown comprises the fourth application apparatus 330, which is set up to apply an adhesive application or adhesive frame to the MEA component arrangements with the carrier frames 20a, 20b, the membrane 30 and the anode/GDL 10 conveyed by the third transport apparatus 130. The adhesive application can be applied, for example, in such a way that the adhesive application surrounds or encompasses the first recess 22 in the first carrier frame 20a and/or in the second carrier frame 20b in a frame-like manner.

The component sections of the cathode/GDL 40 separated by the additional cutting apparatus or additional arranging apparatus 480 are then set up by the additional arranging apparatus 480 on the MEA component sections conveyed by the third transport apparatus 130 with the adhesive applications thereon and fed to the further lamination apparatus 710.

The variants described above merely serve to provide a better understanding of the structure, mode of operation and properties of the objects disclosed herein, they do not limit the disclosure to the embodiments. The figures are schematic, whereby essential properties and effects are shown, in some cases clearly enlarged, in order to clarify the functions, operating principles, technical embodiments and features. Each mode of operation, each principle, each technical embodiment and each feature disclosed in the FIG. or in the text can be freely and arbitrarily combined with all claims, each feature in the text and in the other FIGS., other modes of operation, principles, technical embodiments and features contained in or resulting from this disclosure, so that all conceivable combinations can be assigned to the described procedure. This also includes combinations between all individual embodiments in the text, i.e. in each section of the description, in the claims and also combinations between different variants in the text, in the claims and in the figures. Nor do the claims limit the disclosure and thus the possible combinations of all the features disclosed. All disclosed features are also explicitly disclosed here individually and in combination with all other features.

1. A manufacturing apparatus for manufacturing a membrane electrode assembly (MEA), said manufacturing apparatus comprising:
a first transport apparatus including a first vacuum conveyor belt or a vacuum drum, said first transport apparatus being configured to convey a first carrier frame at a first conveying speed,
a first arranging apparatus including a vacuum drum, said first arranging apparatus being configured to arrange at least one membrane on the first carrier frame while the first carrier frame is being conveyed by the first transport apparatus, and
a second arranging apparatus including a vacuum drum, said second arranging apparatus being configured to arrange a second carrier frame on the membrane while the second carrier frame is being conveyed with the first carrier frame by the first transport apparatus.

2. The manufacturing apparatus according to claim 1, wherein
the first transport apparatus is a vacuum conveyor belt configured to convey the first carrier frame continuously at the first conveying speed, and
the vacuum conveyor belt is configured to convey the first carrier frame with a first MEA component, wherein the first carrier frame is positioned on the first MEA component.

3. The manufacturing apparatus according to claim 2, further comprising:
a third arranging apparatus including a vacuum drum, said third arranging apparatus being configured to arrange the first carrier frame on the MEA component conveyed by the vacuum conveyor belt so that the vacuum conveyor belt conveys the first carrier frame with the first MEA component.

4. The manufacturing apparatus according to claim 1, wherein
the first transport apparatus is a vacuum drum and is configured to convey the first carrier frame continuously at the first conveying speed.

5. The manufacturing apparatus according to claim 4, further comprising:
a third arranging apparatus including a vacuum drum, said third arranging apparatus being configured to arrange the first carrier frame with the membrane and with the second carrier frame on the first MEA component.

6. The manufacturing apparatus according to claim 2, further comprising:
a third arranging apparatus including a vacuum drum, said third arranging apparatus being configured to arrange a second MEA component on a surface of the third arranging apparatus, the first carrier frame, the membrane and the second carrier frame facing away from the first MEA component.

7. The manufacturing apparatus according to claim 1, further comprising
a first and second rotary punching apparatus, wherein
the first punching apparatus is configured to make one or more recesses in the first carrier frame as the first carrier frame is being conveyed by a vacuum drum or by the first transport apparatus, and/or
the second punching apparatus is configured to make one or more recesses in the second carrier frame as the second carrier frame is being conveyed by the second arranging apparatus.

8. The manufacturing apparatus according to claim 4 further comprising:
at least one supply apparatus in combination with the first carrier frame and including a vacuum drum and/or a first rotary punching press configured to co-operate with the supply apparatus, and/or
a further vacuum drum and/or a second rotary punching press configured to co-operate with the second arranging apparatus and/or to co-operate with the further vacuum drum, and/or
a common rotation drive configured to rotate the vacuum drums and/or rotary punching presses simultaneously.

9. The manufacturing apparatus according to claim 6 wherein
the first MEA component includes a gas diffusion layer having an anode or a cathode, and/or
the second MEA component includes a gas diffusion layer having an anode or a cathode, and/or
the membrane is a catalyst-coated membrane.

10. The manufacturing apparatus according to claim 1, further comprising:
a second transport apparatus including a vacuum conveyor belt, wherein
the second transport apparatus is configured to convey the first MEA component at a second conveying speed, and/or
the second transport apparatus is configured to convey the first MEA component continuously or cyclically at the second conveying speed, and/or
the second transport apparatus is configured to convey the first MEA component in the form of a web material or in the form of a plurality of MEA component sections of the first MEA component.

11. The manufacturing apparatus according to claim 10, further comprising:
a transfer apparatus configured to move the MEA component sections from the second transport apparatus to the first transport apparatus or to a third transport apparatus.

12. The manufacturing apparatus according to claim 1, further comprising:
a first provisioning apparatus including a carrier web roller, said first provisioning apparatus being configured to provide the first carrier frame with a first carrier layer, and/or
a second provisioning apparatus including a carrier web roller, said second provisioning apparatus being configured to provide the at least one second carrier frame with a second carrier layer, and/or
a first carrier layer receiving apparatus including a carrier layer roller, said first carrier layer receiving apparatus being configured to receive the first carrier layer after at least a part of the first carrier frame has been detached therefrom, and/or
a second carrier layer receiving apparatus including a carrier layer roller, said second carrier layer receiving apparatus being configured to receive the second carrier layer after at least a part of the second carrier frame has been detached therefrom.

13. The manufacturing apparatus according to claim 12, wherein
the first carrier frame is fixed to the first carrier layer with an adhesive application and/or a heat-soluble adhesive application, and/or
the second carrier frame is fixed to the second carrier layer with an adhesive application and/or a heat-soluble adhesive application.

14. A method for manufacturing a membrane electrode assembly (MEA) comprising:
conveying, with a first transport apparatus including a first vacuum conveyor belt or a vacuum drum, a first carrier frame at a first conveying speed;
arranging, with a first arranging apparatus including a vacuum drum, at least one membrane on the first carrier frame while the first carrier frame is being conveyed by the first transport apparatus; and
arranging, with a second arranging apparatus including a vacuum drum, a second carrier frame on the membrane, while the second carrier frame is conveyed with the first carrier frame by the first transport apparatus.

15. The method according to claim 14, wherein
the first carrier frame is provided with a first carrier layer, wherein the first carrier frame is fixed to the first carrier layer with an adhesive application and/or a heat-soluble adhesive application, and/or
the second carrier frame is provided with a second carrier layer, wherein the second carrier frame is fixed to the second carrier layer with an adhesive application and/or a heat-soluble adhesive application, and/or
a first recess is made in the first carrier frame while the first carrier frame is fixed on the first carrier layer, and/or
a second recess is made in the second carrier frame while the second carrier frame is fixed on the second carrier layer.

16. The method according to claim 15, further comprising at least one of the steps of:
detaching the first carrier frame from the first carrier layer;
detaching the second carrier frame from the second carrier layer;
heating the first and/or the second carrier frame;
arranging a first MEA component including a gas diffusion layer on the first or the second carrier frame and/or arranging a second MEA component including a gas diffusion layer on the first or the second carrier frame; and
introducing additional recesses into the first carrier frame and/or into the second carrier frame using a rotary punching press wherein the additional recesses are adjacent to one or more outer edges of the first recess.
